(19) United States
(12) Patent Application Publication
(10) Pub. No.: US 2018/0113957 A1
(43) Pub. Date: Apr. 26, 2018

(54) DATA PROCESSING DEVICE AND METHOD FOR ASSISTING A USER IN A PRODUCT DEFINITION

(71) Applicant: Data Engineers GmbH, München (DE)

(72) Inventor: Otto Christian Haas, München (DE)

(21) Appl. No.: 15/565,847

(22) PCT Filed: Apr. 12, 2016
(86) PCT No.: PCT/EP2016/057952

§ 371 Date: Oct. 11, 2017

(30) Foreign Application Priority Data
Apr. 14, 2015 (EP) 15163523.2

(51) Int. Cl. G06F 17/50

(52) U.S. Cl. CPC G06F 17/50; G06Q 30/0283; G06F 2217/04; G06F 2217/02

(57) ABSTRACT

A data processing device and a method for assisting a user in a product definition using a data processing device are proposed. The method comprises the steps: receiving a user input of a user concretizing a characteristic of a workpiece, transmitting a message representing the characteristic to a database, automatically selecting at least one entry from the database based on the characteristic, and outputting a notification representing information from the entry with respect to the characteristic to the user.

### FIELD OF THE INVENTION

The present invention relates to a data processing device as well as a method for assisting a user in a product definition using a data processing device. Particularly, the present invention relates to possibilities of rapidly defining products, an improved state of information during the product definition and an automatic consideration of constructive alternatives. In addition, the data processing device allows the inclusion of customer specific specifications and characteristics (also “features”) for improving the constructive alternatives.

### BACKGROUND OF THE INVENTION

Drafting programs (computer-aided drafting, computer-aided design, CAD), with which a designer can design a new workpiece, are known in the state of the art. Additionally, integrating databases such that components can be added to the workpiece by selecting them from the database is also known. Normally, this is accomplished by the user searching the database for a suitable component (e.g. a screw), potentially selecting a suitable element and thus adding it to the workpiece. Subsequently, the user must independently check the actual suitability of the component for the use in the workpiece. The user must also independently consider and check alternatives from the database. Lastly, the user selects the most suitable component from the database or designs a new component himself, which is associated with additional costs for the construction, testing, and production.

### SUMMARY OF THE INVENTION

One embodiment provides a method for assisting a user to concretize a product definition using a computer-aided design system. The method comprises receiving, with a computer-aided design system, a characteristic of a component associated with a workpiece; transmitting, with a transceiver, a message representing the characteristic of the component to a database, wherein the database includes a plurality of component definitions associated with the workpiece; automatically selecting, with the computer-aided design system, at least one entry associated with the component from the database based on the characteristic of the component; and outputting a notification, to a display, representing information from the entry with regard to the characteristic associated with the component.

Another embodiment provides a data processing device for assisting a user in a product definition. The data processing device comprises a user to receive a user input including a characteristic of a component associated with a workpiece; a transceiver device configured to transmit a first message representing the characteristic of the component to a database, and receive a second message representing an automatically selected entry from the database based on the characteristic; and an output device configured to output a notification representing information from the automatically selected entry with regard to the characteristic of the component.

Another embodiment provides a method for determining a price of a component associated with a workpiece while operating a computer-aided design system. The method comprises receiving, with a user interface of the computer-aided design system, a characteristic of a component associated with a workpiece; transmitting, with a transceiver coupled to the computer-aided design system, a message representing the characteristic of the component associated with the workpiece to a database, wherein the database includes a plurality of entries representing one or more characteristics of a plurality of components associated with the workpiece, the plurality of entries including the price associated with each of the plurality of components associated with the workpiece; extracting the plurality of entries representing the one or more characteristics of the plurality of components associated with the workpiece from the database; generating an arithmetic mean of the plurality of entries; and outputting a notification associated with the arithmetic mean of the plurality of entries.

It is the object of the present invention to optimally assist a user in a product definition using a data processing device.

Another object is to significantly reduce the development times during the product definition through the improved provision of information via the data processing device.

According to the invention, the object determined above is solved by a method for assisting a user in a product definition through a data processing device. For example, the user can be a designer or a product designer who operates an electronic data processing device. The user designs a product, referred to as “workpiece” during the development process in the scope of the present invention, in the data processing device. The workpiece has properties and can include independent components, which are to be specified and occasionally iteratively concretized during the product definition. To achieve this, the user interacts via a user interface with the data processing device, through which he carries out inputs for concretization of a characteristic of the workpiece or respectively one of its components. The user input can be carried out via a keyboard, a trackpad, a mouse, speech input, and/or gaze and gesture control. Specifically, according to the invention, it is provided that the user input is carried out “directly on the workpiece”, meaning specifically that no selection of the user from a database or a list is carried out by the user input. The workpiece can be shown as a visual representation (“drawing” or 3D model) on a display of the data processing device. The user input can represent an interaction of the user with the drawing. For example, the user can change a dimension, a size, a material property, or the like of the workpiece. Subsequently, a message representing the changed characteristic is transmitted to a database. In other words, after the successful concretization, a data packet representing the changed characteristic is defined and transmitted to the database. At least one entry from the database is selected automatically based on the characteristic. For example, the entry can represent a component, which is in regard to one characteristic or multiple characteristics similar to the component of the workpiece concretized (“changed”) by the user input. The entry, specifically its characteristic, can correspond to or can have a predetermined measure of accordance to the characteristic contained in the message. Naturally, multiple entries from the database can be selected automatically and be made to be the basis of a proposal to the user. Lastly, a notification representing the information from the entry or the entries regarding the characteristic is output to the user. For example, the user can be notified about which entries from the database correspond to the concretized characteristic best. Alternatively or additionally, a notification concerning which circumstances must be considered when using the characteristic/the component in the scope of the defined product can be transmitted to the user based on the entries. For example, client specific performance parameters, durability, contained pollutants, process technical boundary conditions, or the like can be included in the notification. The data processing device used in the scope of the method according to the invention is distinguished from all conventional methods by a data processing of large data amounts and extraction of price-setting variables from these data amounts, which describe already existing and similar workpieces or components. These can either have been designed in-house or (e.g. anonymized) out of house and can be offered as stock goods, for example.

In this way, the user is automatically and proactively informed about the effects of the concretization of the characteristics of the workpiece. Accordingly, because of the present invention, the user can react quickly to the expected effects of his concretization of characteristics, which accelerates the product development process and improves the concretization of characteristics.

Preferably, transmitting of the message representing the characteristic to the database can occur during the response to receiving the user input. Thus, immediately after accomplished concretization, the database is consulted in order to output a notification representing information from the entry to the user. This offers the advantage that the user does not have to carry out a further interaction to receive information regarding the entries in the database for the characteristic.

For example, the characteristic can concretize a category of a component for the workpiece. For example, a screw, a display, an operating button, a seal, a hinge, or the like can be defined as such by the concretization of the characteristic. This can be achieved by an explicit input by the user, through which he assigns the category (e.g. via text input and/or via a selection menu) to the component. Alternatively or additionally, the category can also be recognized automatically. For example, if a bolt includes a thread, it can be classified automatically as “stud” or “stud bolt”, this information can be integrated into the message to the database and the database can be searched for studs with similar dimensions and thread properties. Alternatively or additionally, the shape of the workpiece can be concretized by the user newly determining an edge length, a proportion and/or a position of a mechanical characteristic (e.g. a drill hole), for example. Also, another mechanical parameter (e.g. surface roughness, strength, surface finish or coating) as well as an electric property of the component can be specified by the user input. If the workpiece is for example an electronic user equipment, the characteristic can define a specification of its display element (“displays”). For example, the display resolution, the brightness, the size and/or a display technology can be concretized by a user input, such that the notification can include corresponding information on similar, already available displays, which the user should consider, to keep the development effort and production costs low. Alternatively or additionally, a material technical specification of the workpiece (e.g. a material, a processing technology, a coating, a finish, an alloy) can concretize the workpiece and be used for the output of information in the form of the notification about similarly specified, available components.

Based on predefined characteristics of the component drawn by the user, a category of the component can be automatically identified. For example, whether it is a component of a certain category can be automatically identified based on the dimensions, a definition of the material to be used, and/or a required property of the component. The category can already be identified within the data processing device, for example, and be written in the message to the database. Alternatively or additionally, the category for the component can be identified decentrally (e.g. within the database) such that an enlarged basis of information is used for finding a suitable category for the component.

The user can design a product of electrical engineering (e.g. an electrical, particularly electronic device, for example, a wireless communications device, tablet, or the like) using the data processing device. Alternatively or additionally, the product definition may define a mechanical component which is to be categorized into the field of automotive engineering, aviation/aerospace, energy generation, or the like.

The data processing device can be connected to the database with regard to information technology via exchange through the internet and/or an intranet. Accordingly, many databases can communicate with the data processing device in the same way as described exemplarily above in conjunction with a single database. Accordingly, the notification for the user concerning the information from the entry can include a plurality of pieces of information concerning a plurality of entries from the databases. The selection concerning which information is included in the notification can, for example, be defined within the data processing device. In this way, it can be optimally achieved that the user only receives the information of highest relevance.

The database operator can, for example, be a manufacturer and/or a dealer and/or a customer for components and products. All market participants stated above usually operate production facilities or rather parts warehouses, which can be included in the product definition regarding information technology and used for the acceleration and improvement of the product development process via the present invention.

The entry in the database can, for example, unambiguously label a completely specified article (e.g. based on an article number and/or an order number), which includes a characteristic with a predetermined measure of similarity to the characteristic of the workpiece represented in the message. The article can, for example, be for sale or at least be specified as “ready for sale”. Accordingly, a sales price can also be assigned as information to the entry, which is communicated to the user within the scope of the notification. In this respect, the database can be assigned to a manufacturer, a dealer and/or a hauler and be connected to the data processing device for use by the user.

For securing the entries in the database against an unauthorized access, the data processing device may have been authorized via an examination of the user profile to transmit the message to the database and therefore retrieve information regarding the characteristic from the entries of the database. Such an integration of the database in a product defining process can greatly accelerate the production of prototypes, small batch series, and large batch series.

To further assist the user, the entries in the database can also specify availability, delivery time, etc., which can label the suitability of one article or the other for use in the concretized workpiece. The article's characteristic in the database can ensure consideration in the notification to the user through a predetermined measurement of similarity to its characteristic represented in the message. For example, it can be ensured that certain dimensions conform with a minimal percentage to those of the workpiece defined in the message. The same applies for other properties such as e.g. temperature stability, mechanical stability, corrosion resistance, mass, compatibility with other substances and compounds contained in the workpiece, clearance guidelines for use in certain fields, etc.

The notification can include, for example, technical performance characteristics, which are specified in the database. In this way, the operator of the database can notify the user as soon as possible about which boundary conditions the use of the item represented by the entry in the database has. For example, its mass and/or dimensions and/or an average lifetime and/or an average failure rate of the component over time and/or a stability parameter (mechanical stability, temperature and/or acid resistance) and/or a technical parameter can be included in the information of the notification for the user. Alternatively or additionally, client specific preferences such as e.g. colors and special performance characteristics can be shown.

Also, an availability and/or an expected delivery time can be characterized by the notification. Both of the above mentioned pieces of information can, especially considering a predetermined processing and/or manufacturing location for the workpiece and/or considering a storage location assigned to an entry from the database, be determined and output to assess whether the article assigned to the entry is worth considering for use in the defined workpiece or rather product.

Advantageously, the number of manufacturers, or rather suppliers, that are worth considering for the currently defined item is automatically determined and highlighted via the notification during the response to the concretization of the characteristic. On the one hand, this is necessary for the manufacturing or rather delivery reliability. On the other hand, such information can be decisive for whether the current product definition is worth considering because terminal device manufacturers sometimes define a minimal amount of providers to guarantee supply reliability. Accordingly, the notification can include a quantitative statement about the number of sources that can be considered for the currently defined item. Alternatively or additionally, the notification can include a qualitative (classifying) statement whether the number of considerable suppliers is unproblematic, problematic, or insufficient.

Alternatively or additionally, a comparison between the characteristic of the workpiece/the component represented in the message and the entry from the database can be characterized and, in particular, be quantified. For example, a notification concerning the difference between the entry and the component can be output to the user. Concerning a mass of the respective items, the notification can also notify about an excess or deficiency in weight, a deviation from a desired minimal lifetime or give a notification about which further adjustments can be necessary when using one of the components represented by an entry in the database. Accordingly, comparisons between the component and multiple entries and/or between different entries from the database or the databases can be included in the notification.

The entry from the database can, for example, represent an article from an internet-based sales platform. In particular, the sales platform can be addressed to end customers. Such sales platforms sometimes offer an immense number of articles which are represented in regard to data technology based on a plurality of characteristics. This basis of information provides a considerable potential for the method according to the invention in assisting the user with the product definition. In addition, commercial and logistical concrete information for each article is available for retrieval, through which the user receives planning security for the product definition e.g. regarding the construction of a prototype. During implementation of the method according to the invention, a significant number of entries of the database can be considered, whereby a statistical evaluation of those entries that are similar to the workpiece or the component of the workpiece concretized by the user can be employed. In particular, single characteristics of the workpiece can be extracted and characterized from the statistical evaluations. This will be explained shortly in the following based on an example:

If the user defines a module for data transmission via Bluetooth for a wireless communication device, without a concrete knowledge of the structure of a Bluetooth module, a plurality of wireless communication devices with such a module offered on the sales platform can be compared to offered products with corresponding properties without such a module. In this way, it is possible to quickly and reliably evaluate how a Bluetooth module affects dimensions, mass, battery lifetime, and price and the sales possibilities of a wireless communication device. This procedure can be transferred to a plurality of possible equipment features for products which have been electronically specified in a similar way and which are especially offered for sale on the internet as components of products.

An alternative application case arises for the conception of a new washing machine. For such commodities the characteristics “washer load mass”, “energy consumption”, “water consumption”, “loudness during washing/spinning”, and the brand name proved highly relevant for the achievable price for the end customer. The appreciation can depend on the cultural background of the end customer and therefore data can be collected country-specifically and can be evaluated country-specifically. If a database, which includes a plurality of models of washing machines introduced to the market with regard to the aforementioned characteristics, is accessed in a manner according to the invention during the conception or rather the product definition, then the influence of each parameter on the achievable price and the respective appreciation of the customer (for example, within a predetermined culture group) can be determined quickly, cost-efficiently and precisely.

In other words, the present invention makes a “top-down approach” possible, so that boundary conditions in the construction process can be identified and estimations with regard to a plurality of properties of a component of a workpiece can be conducted with the least possible effort and as soon as possible. In the first trials, a very low variance was shown for properties of such components identified according to the invention over the available entries of the information pool.

Based on the entry from the database or rather based on a measure of similarity to the characteristic represented in the message, the user can subsequently be prompted to decide if a characteristic of the entry should actually be used for the workpiece or even possibly if all characteristics of the entry should be used for the workpiece or rather if the article defined in such a way should be used for the workpiece. For this, the notification can include a query and especially command buttons, which represent a respective entry or rather a respective characteristic as suitable classified entries. If the user activates a respective command button, the concretized characteristic of his workpiece will be defined according to the entry. In addition, further characteristics of the workpiece can be adjusted according to the selected entry. This allows for a comfortable assistance of a user in a modular product definition. In other words, the user is notified about which possibly usable components are already available for his workpiece. This accelerates the product definition, lowers the costs and reduces the effort for trials, since trial results of existing products can be accessed.

According to a second aspect of the present invention, a data processing device for assisting a user in a product definition is proposed. This includes a user interface, which is set up to receive a user input of a user concretizing a characteristic of a workpiece, from which the product to be defined should be formed. The user interface can, for example, support a tactile input, an acoustic input, a sensory input, or the like. A transceiver device is set up to define a message representing the characteristic and transmit it to a database. The transceiver device can support a circuit-switched and/or a wireless data transmission. In addition, the transceiver device is set up to receive a message representing an entry automatically selected based on the characteristic from the database. In this way, the data processing device is capable of assigning the information supplied by the database to the characteristic modified by the user input. An output device, which can, for example, be a component of the user interface, is set up to output a notification representing information from the entry in regard to the characteristic to the user. Generally, a display or a different visual display device is provided as the output device. This can be complemented by an acoustic and/or haptic output possibility. The data processing device formed in this way is therefore set up to implement a method in conjunction with the database or rather with multiple databases as it has been described in detail in conjunction with the first mentioned aspect of the invention. Insofar, to avoid repetition, the explanations regarding the characteristics, combinations of characteristics, and the advantages resulting from these will be referred to.

Examples of characteristics, which the user can concretize for the workpiece, are for a wireless user terminal device (e.g. “tablet”, “mobile phone”, “notebook”) e.g. the display size and its resolution, the available internal storage, possible storage expansions (“memory card slots”), number of cameras and resolution of the cameras, mass, battery capacity, battery lifetime, number of contact points that the touchscreen can resolve, the operating system, number of usable radio standards (tri-band, quad-band, etc.), usable data communication standards (Bluetooth, WLAN), compatibility with peripheral devices and many more technical properties. Since the manufacturers publish data lists of the aforementioned properties and provide them to testing institutions, online dealers and grid operators, a corresponding database for use in the scope of a method according to the invention can support an assisting of the user in the product definition corresponding to the designs described above. The product that is to be defined according to the invention can be, for example, so-called white goods (house work such as cooking, washing), brown goods (consumer electronics), red goods (heating systems) or grey goods (IT, EDP). However, it does not have to involve an end consumer product.

### BRIEF DESCRIPTION OF THE DRAWINGS

Implementation examples of the invention will be described in detail in the following with reference to the accompanying drawings. In the drawings:

FIG. 1 is a schematic sketch for illustrating the method according to the invention with an implementation example of a data processing device according to the invention; and

FIG. 2 is a flow chart showing steps of an implementation example of a method according to the invention for assisting the user in a product definition.

### DETAILED DESCRIPTION

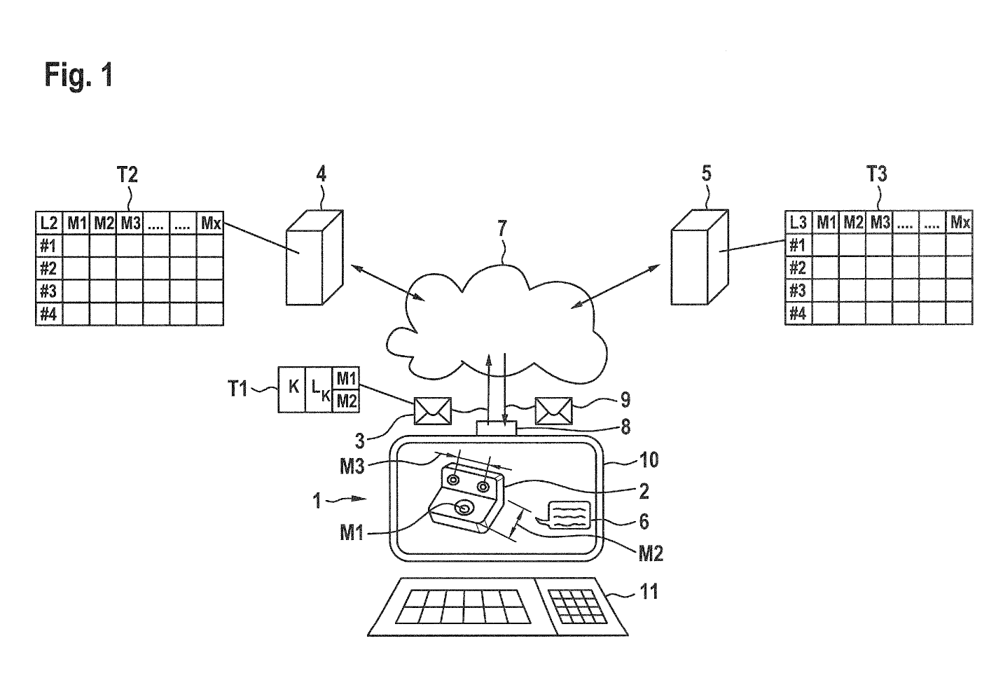

FIG. 1 shows a CAD-computer 1 as a data processing device, which has a display 10 as its output device of a user interface, which also has a keyboard 11. On the display 10, the user defines a metal angle 2 as a workpiece, which has drilled holes as characteristics M1, which can be concretized by the user. Further characteristics M2, M3 are the distance between two drilled holes in a vertical part of the angle 2 and the depth of the angle 2. During the response to the definition of the characteristics M1, M2, the CAD-computer 1 defines a message 3, which is sent to the internet 7 via a Transceiver device 8. The message 3 includes a table T1, which specifies a category K (“metal angle”), location information L_{K} for labeling the construction location and the characteristics M1 and M2. The message 3 is sent via the internet 7 to two data servers 4, 5 in which the tables T2 or rather T3 are saved. The tables T2, T3 include the location information L2, L3, through which the information regarding the storage locations of the articles represented by the entries #1 to #4 are labeled. The articles #1 to #4 include on their part characteristics M1, M2, M3, M. Using the table 1 in the message 3, those entries #1 to #4 from the tables T2, T3 that have a respective highest measure of accordance with regard to the characteristics M1, M2 from the table 1 are determined. Accordingly, the databases 4, 5 transmit messages 9 to the CAD-computer 1, in which all characteristics of the selected entries #1 to #4 are included. The information relevant for the user in the messages 9 is extracted by the CAD-computer 1 and is shown on the display 10 in the form of a notification 6. In this way, the user receives, for example, the information that identically constructed angles 2 with slightly differently performed drillings can be obtained and delivered to the location L_{K} within one week through a provider in the location L2.

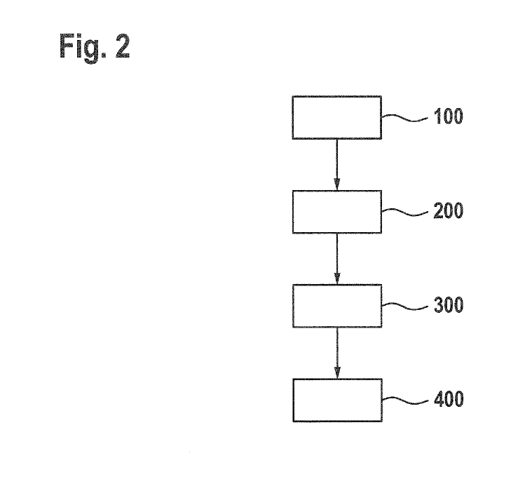

FIG. 2 shows steps of an implementation example of a method according to the invention for assisting a user in a product definition using a data processing device. In step 100, a user input from a user that concretizes a characteristic of a workpiece is received. This can, for example, occur through adjustment of a dimension and/or a position of a characteristic on the workpiece, as it occurs sometimes graphically in CAD-computers. In step 200 a message representing the characteristic is sent to a database. This is achieved in this example by exchange of an intranet and the internet. Subsequently, in step 300, at least one entry from the database is automatically selected based on the characteristic. Hereby, the entry out of the database that has a highest measure of correspondence with regard to the concretized characteristic is selected automatically. In step 400 a notification that represents information from the entry regarding the concretized characteristic is output to the user. In this way, the application receives proactive assistance in the product definition within the scope of a concretization of characteristics and effects associated with these.

Even if the aspects and advantageous embodiments according to the invention have been described in detail with the implementation examples in conjunction with the drawings, modifications and combinations of characteristics of the shown implementation examples are possible for those skilled in the art without departing from the spirit of the invention, the scope of which is defined by the attached claims.

Various features of the invention are set forth in the following claims.

1. A method for assisting a user to concretize a product definition using computer-aided design system, the method comprising:
receiving, with a computer-aided design system, a characteristic of a component associated with a workpiece;
transmitting, with a transceiver, a message representing the characteristic of the component to a database, wherein the database includes a plurality of component definitions associated with the workpiece;
automatically selecting, with the computer-aided design system, at least one entry associated with the component from the database based on the characteristic of the component; and
outputting a notification, to a display, representing information from the entry with regard to the characteristic associated with the component.

2. The method of claim 1, wherein
transmitting the message representing the characteristic of the component to the database occurs automatically in response to receiving a user input to the computer-aided design system.

3. The method of claim 1, wherein the product definition is concretized using a computer-aided design program, which is executed on the computer-aided design system.

4. The method of claim 2, wherein the characteristic of the component includes an item selected from the group consisting of:
a category of the component for the workpiece,
a form of the component,
a mechanical specification of the workpiece,
an electrical specification of the workpiece, and
a material specification of the workpiece.

5. The method of claim 1, further comprising:
extracting a category for the component of the workpiece from a user input to the computer-aided design system; and
defining the category of the component in the message to the database.

6. The method of claim 1, wherein the product definition refers to an item selected from the group consisting of:
an electrical component,
an electronic component, and
a mechanical component.

7. The method of claim 1, wherein the computer-aided design system communicates with the database via at least one of
an internet and
an intranet.

8. The method of claim 1, wherein
the entry in the database unambiguously labels a specified component having a first characteristic with a measure similar to the characteristic of the workpiece represented in the message.

9. The method of claim 1, wherein the notification, comprises an item selected from the group consisting of:
fabrication requirements,
a mass,
dimensions,
an average lifetime,
an average failure rate over time,
a stability parameter,
a mechanical parameter,
compatibility with compounds contained in the workpiece,
a predetermined construction location for the workpiece,
an availability and,
a delivery time.

10. The method of claim 1, wherein the entry of the database represents an article from an internet-based sales platform.

11. The method of claim 1, further comprising:
generating the notification based on a difference of the characteristics of at least two entries in a database associated with an internet-based sales platform.

12. The method of claim 1, further comprising:
prompting the user to decide whether a characteristic of the entry should be used for the workpiece based on the entry from the database.

13. A data processing device for assisting a user in a product definition, the data processing device comprising:
a user interface configured to receive a user input including a characteristic of a component associated with a workpiece;
a transceiver device configured to
transmit a first message representing the characteristic of the component to a database,
receive a second message representing an automatically selected entry from the database based on the characteristic of the component; and
an output device configured to output a notification representing information from the automatically selected entry with regard to the characteristic of the component.

14. The data processing device of claim 13, wherein a first entry in the database represents a price of a first component.

15. The data processing device of claim 13, wherein the characteristics of the component include an item selected from the group consisting of:
fabrication requirements,
a mass,
dimensions,
an average lifetime,
an average failure rate over time,
a stability parameter,
a mechanical parameter,
compatibility with compounds,
a predetermined construction location,
an availability, and
a delivery time associated with one of the component and the workpiece.

16. The data processing device of claim 13, wherein the transceiver device is configured to automatically transmit the message representing the characteristic of the component to the database in response to receiving a user input.

17. The data processing device of claim 13, wherein the notification characterizes an item selected from the group consisting of:
fabrication requirements,
a mass,
dimensions,
an average lifetime,
an average failure rate over time,
a stability parameter,
a mechanical parameter,
contents including problematic compounds,
a predetermined construction location for the workpiece,
an availability schedule, and
a delivery time.

18. A method for determining a price of a component associated with a workpiece while operating a computer-aided design system, the method comprising:
receiving, with a user interface of the computer-aided design system, a characteristic of a component associated with a workpiece;
transmitting, with a transceiver coupled to the computer-aided design system, a message representing the characteristic of the component associated with the workpiece to a database, wherein the database includes a plurality of entries representing one or more characteristics of a plurality of components associated with the workpiece, the plurality of entries including the price associated with each of the plurality of components associated with the workpiece;
extracting the plurality of entries representing the one or more characteristics of the plurality of components associated with the workpiece from the database;
generating an arithmetic mean of the plurality of entries; and
outputting a notification associated with the arithmetic mean of the plurality of entries.

19. The method of claim 18, further comprising:
extracting customer information associated with an item selected from the group consisting of an internet-based retailer, a dealer, and a manufacturer.

20. The method of claim 18, further comprising:
automatically selecting the plurality of entries from the database based on a user input.
